(19) United States
(12) Patent Application Publication
(10) Pub. No.: US 2022/0413972 A1
(43) Pub. Date: Dec. 29, 2022

(54) ELECTRONIC FILE MIGRATION SYSTEM AND METHODS OF RESTORING COPIED DATA BETWEEN STORAGE SYSTEMS

(71) Applicant: KOMPRISE INC., CAMPBELL, CA (US)

(72) Inventors: MOHIT DHAWAN, CAMPBELL, CA (US); MICHAEL PEERCY, CAMPBELL, CA (US); KUMAR GOSWAMI, CAMPBELL, CA (US)

(73) Assignee: KOMPRISE INC, CAMPBELL, CA (US)

(21) Appl. No.: 17/850,611

(22) Filed: Jun. 27, 2022

Related U.S. Application Data
(60) Provisional application No. 63/215,736, filed on Jun. 28, 2021.

(51) Int. Cl. G06F 11/14; G06F 16/11

(52) U.S. Cl. CPC G06F 11/1469; G06F 16/119; G06F 11/1464; G06F 2201/84

(57) ABSTRACT

An electronic file migration system has a processor. A memory is coupled to the processor, the memory storing program instructions that when executed by the processor, causes the processor to: copy a plurality of files from a source storage device to a destination storage device, wherein a first set of files are copies of files themselves and a second set of files are copied as symbolic links to the second set of files.

### RELATED APPLICATIONS

This patent application is related to U.S. Provisional Application No. 63/215,736 filed Jun. 28, 2021, entitled “ELECTRONIC FILE MIGRATION SYSTEM AND METHODS OF RESTORING COPIED DATA BETWEEN STORAGE SYSTEMS” in the name of the same inventor, and which is incorporated herein by reference in its entirety. The present patent application claims the benefit under 35 U.S.C § 119(e).

### TECHNICAL FIELD

The present application generally relates to a network-based data backup and migration systems, and, more specifically to a system and method to first make the recovery copy available and, in the background, restore a new source copy either on the original source or in a new restore location. Copying files most likely to be accessed first while copying links to files less likely to be accessed allows switching to the highly performant restore copy sooner than otherwise

### BACKGROUND

Storage administrators may need to back up data stored on file storage systems due to the possibility of a disaster destroying the data, the file storage, or even the entire locality of the file storage. Presently, there are existing mechanisms for rapidly backing up and restoring data from such file storage systems. However, these existing mechanisms are generally very expensive both in terms of hardware and software in order to achieve the expected performance, costing a multiple of the primary storage in its full protection.

In general, a significant amount of data may not be critical enough to warrant this expense to back up. Managers of this non-critical data may take infrequent inexpensive backups, such as to tape, that cannot be quickly restored.

Thus, it may be desirable to provide a system and method that enables a middle ground, where data is not backed up to an equally performant file storage system, nor is it backed up infrequently solely to an extremely low performance device. Rather, the data may be backed up periodically to less expensive storage that offers the same access capabilities as the primary storage at a lower performance and a lower cost. Recovery in the event of a disaster could be immediately served by the back-up location while the data can be restored to the original primary store or a different primary store very rapidly using novel techniques.

A disaster recovery copy of data needs to be immediately available and mounted as readily as the original source in the event of a disaster. But it is not necessarily the case that the recovery copy needs to be as performant as the original source. Rather, the recovery copy could be less performant than the original source while it was being used as the recovery copy so long as it could be converted into a restored copy that was as performant as the original source.

Therefore, it would be desirable to provide a system and method that overcomes the above. The system and method would use novel techniques to first make the recovery copy available and, in the background, restore a new source copy either on the original source or in a new restore location. The system and method would copy files most likely to be accessed first while copying links to files less likely to be accessed, all of which allows switching to the highly performant restore copy sooner than otherwise. In order to use a high performance restore copy as the primary copy as soon as possible, the system and method also provides access to the recovery copy through an intelligent file system, such as that of U.S. Pat. No. 10,198,447, that can immediately duplicate any changes to the recovery copy back to the restore copy.

### SUMMARY

In accordance with one embodiment, an electronic file migration system is disclosed. The electronic file migration system has a processor. A memory is coupled to the processor, the memory storing program instructions that when executed by the processor, causes the processor to: copy a plurality of files from a source storage device to a destination storage device, wherein a first set of files are copies of files themselves and a second set of files are copied as symbolic links to the second set of files.

In accordance with one embodiment, an electronic file migration system is disclosed. The electronic file migration system has a processor. A memory is coupled to the processor, the memory storing program instructions that when executed by the processor, causes the processor to: copy a plurality of files from a source storage device to a destination storage device, wherein a first set of files are copies of files themselves and a second set of files are copied as symbolic links to the second set of files. The first set of files are files that have been accessed after a predetermined date and the symbolic links are links to the second set of files stored on the source storage device.

### BRIEF DESCRIPTION OF THE DRAWINGS

The present application is further detailed with respect to the following drawings. These figures are not intended to limit the scope of the present application but rather illustrate certain attributes thereof. The same reference numbers will be used throughout the drawings to refer to the same or like parts.

FIG. 1 is a diagram of an exemplary electronic file migration system according to one aspect of the present application;

FIG. 2 is a simplified block diagram showing an illustrative computing device/server depicted in FIG. 1 in accordance with one aspect of the present application;

FIG. 3 is a simplified diagram showing an exemplary embodiment of restoring of files and static symbolic links according to one aspect of the present application;

FIG. 4 is a simplified diagram showing an exemplary embodiment of restoring of files and dynamic symbolic links according to one aspect of the present application; and

FIG. 5 is a simplified diagram showing an exemplary embodiment of restoring of files due to access or write according to one aspect of the present application due to access or write.

### DESCRIPTION OF THE APPLCIATION

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

The detailed description is presented largely in terms of description of shapes, configurations, and/or other symbolic representations that directly or indirectly resemble one or more novel electronic file and object analysis and management systems and methods of operating such novel systems. These descriptions and representations are the means used by those experienced or skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment. Furthermore, separate or alternative embodiments are not necessarily mutually exclusive of other embodiments. Moreover, the order of blocks in process flowcharts or diagrams representing one or more embodiments of the invention do not inherently indicate any particular order nor imply any limitations in the invention.

Moreover, for the purpose of describing the invention, an “electronic system,” a “computing unit,” and/or a “main computing unit” are each defined as electronic-circuit hardware device, such as a computer system, a computer server, a data storage unit, or another electronic-circuit hardware unit controlled, managed, and maintained by a file migration module, which is executed in a CPU and a memory unit of the electronic-circuit hardware device for the electronic file migration management.

In addition, for the purpose of describing the invention, a term “computer server” is defined as a physical computer system, another hardware device, a software and/or hardware module executed in an electronic device, or a combination thereof. For example, in context of an embodiment of the invention, a “computer server” is dedicated to executing one or more computer programs for executing and maintaining a robust and efficient file and object management system among varieties of storage systems. Furthermore, in one embodiment of the invention, a computer server is connected to one or more data networks, such as a local area network (LAN), a wide area network (WAN), a cellular network, and the Internet.

Embodiments of the exemplary system and method may restore files from a recovery storage system A to a restore storage system B, with each file being handled in one of two ways depending on a chosen policy. Files that are desired on the restore storage system B may be copied to the restore storage system B. Files that are not desired on the restore storage system B may have symbolic links written on the restore storage system B that may refer directly to the files on the recovery storage system A. The system and method may continue to migrate files from the recovery storage system A to the restore storage system B even after the restore storage system B becomes the primary storage system, but this time may overwrite links that were previously copied as links with copies that are complete files. The files that were previously copied as links may be again divided into two sets, one set of files that should be copied to storage system B as files and the complementary set that should remain copied to storage system B as links. This may be repeated until all desired files, or all files, from storage system A are copied as files to storage system B. The system and method may place dynamic links in the style of U.S. Pat. No. 10,198,447 on the new storage system B where those dynamic links are serviced by an intelligent migration platform that dynamically dereferences the dynamic link and serves the file from the old storage system A. The system and method may recognize the access of files on the intelligent migration platform handling the dynamic links and more rapidly replace the dynamic link on the restore storage system B with the newly accessed file on the recovery system A. The system and method may recognize the writing of files on the intelligent migration platform handling the dynamic links and more rapidly replace the dynamic link on the restore storage system B with the newly written file on the recovery system A.

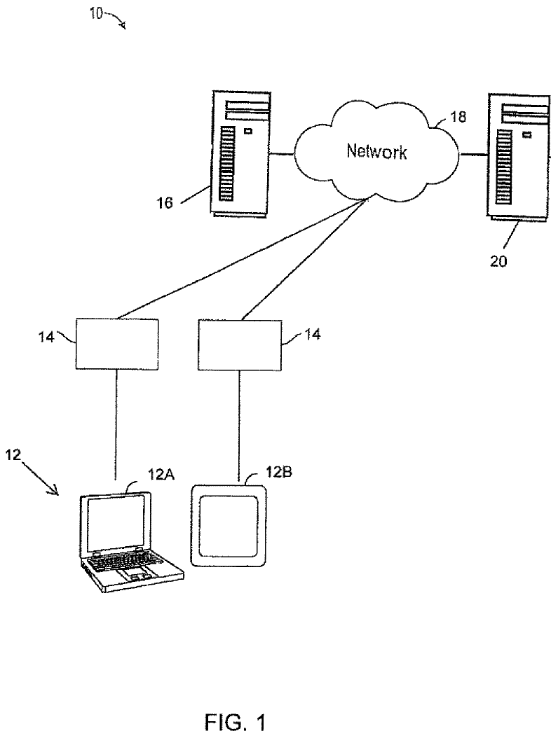

Referring to FIG. 1, an electronic file migration system 10 (hereinafter system 10) may be seen. The components of the system 10 may be coupled through wired or wireless connections.

The system 10 may have one or more computing devices 12. The computing devices 12 may be a client computer system such as a desktop computer, handheld or laptop device, tablet, mobile phone device, server computer system, multiprocessor system, microprocessor-based system, network PCs, and distributed cloud computing environments that include any of the above systems or devices, and the like. The computing device 12 may be described in the general context of computer system executable instructions, such as program modules, being executed by a computer system as may be described below. In the embodiment shown in FIG. 1, the computing device 18 may be seen as a desktop/laptop computing system 12A and a tablet device 12B. However, this should not be seen in a limiting manner as any computing device 12 described above may be used.

The computing devices 12 may be loaded with an operating system 14. The operating system 14 of the computing device 12 may manage hardware and software resources of the computing device 12 and provide common services for computer programs running on the computing device 1.

The computing devices 12 may be coupled to a server 16. The server 16 may be used to store data files, programs and the like for use by the computing devices 12. The computing devices 12 may be connected to the server 16 through a network 18. The network 18 may be a local area network (LAN), a general wide area network (WAN), wireless local area network (WLAN) and/or a public network. In accordance with one embodiment, the computing devices 12 may be connected to the server 16 through a network 18 which may be a LAN through wired or wireless connections.

The system may have one or more servers 20. The servers 20 may be coupled to the server 16 and/or the computing devices 12 through the network 18. The network 18 may be a local area network (LAN), a general wide area network (WAN), wireless local area network (WLAN) and/or a public network. In accordance with one embodiment, the server 16 may be connected to the servers 20 through the network 18 which may be a WAN through wired or wireless connections.

The servers 20 may be used for migration and data back-up. The server 20 may be any data storage devices/system. In accordance with one embodiment, the server 20 may be cloud data storage. Cloud data storage is a model of data storage in which the digital data is stored in logical pools, the physical storage may span multiple servers (and often locations), and the physical environment is typically owned and managed by a third-party hosting company. However, as defined above, cloud data storage may be any type of data storage device/system.

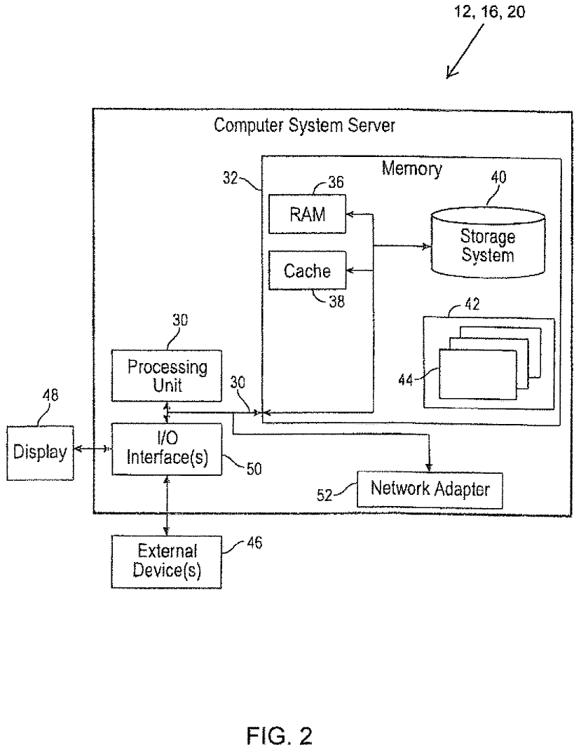

Referring now to FIG. 2, the computing devices 12 and/or servers 16, 20 may be described in more detail in terms of the machine elements that provide functionality to the systems and methods disclosed herein. The components of the computing devices 12 and/or servers 16, 20 may include, but are not limited to, one or more processors or processing units 30, a system memory 32, and a system bus 34 that couples various system components including the system memory 32 to the processor 30. The computing devices 12 and/or servers 16, 20 may typically include a variety of computer system readable media. Such media may be chosen from any available media, including non-transitory, volatile and non-volatile media, removable and non-removable media. The system memory 32 could include one or more personal computing system readable media in the form of volatile memory, such as a random access memory (RAM) 36 and/or a cache memory 38. By way of example only, a storage system 40 may be provided for reading from and writing to a non-removable, non-volatile magnetic media device typically called a “hard drive”.

The system memory 32 may include at least one program product/utility 42 having a set (e.g., at least one) of program modules 44 that may be configured to carry out the functions of embodiments of the invention. The program modules 44 may include, but is not limited to, an operating system, one or more application programs, other program modules, and program data. Each of the operating systems, one or more application programs, other program modules, and program data or some combination thereof, may include an implementation of a networking environment. The program modules 44 generally carry out the functions and/or methodologies of embodiments of the invention as described herein.

The computing device 12 and/or servers 16, 20 may communicate with one or more external devices 46 such as a keyboard, a pointing device, a display 48, or any similar devices (e.g., network card, modern, etc.). The display 48 may be a Light Emitting Diode (LED) display, Liquid Crystal Display (LCD) display, Cathode Ray Tube (CRT) display and similar display devices. The external devices 46 may enable the computing devices 12 and/or servers 16, 20 to communicate with other devices. Such communication may occur via Input/Output (I/O) interfaces 50. Alternatively, the computing devices and/or servers 18, 20 may communicate with one or more networks 18 such as a local area network (LAN), a general wide area network (WAN), and/or a public network via a network adapter 52. As depicted, the network adapter 52 may communicate with the other components of the computing device 18 via the bus 34.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, microcode, etc.) or an embodiment combining software and hardware aspects that may all generally be referred to herein as a “circuit,” “module,” or “system.” Furthermore, aspects of the disclosed invention may take the &tin of a computer program product embodied in one or more computer readable media having computer readable program code embodied thereon.

Any combination of one or more computer readable media (for example, storage system 40) may be utilized. In the context of this disclosure, a computer readable storage medium may be any tangible or non-transitory medium that can contain, or store a program (for example, the program product 42) for use by or in connection with an instruction execution system, apparatus, or device. A computer readable storage medium may be, for example, but not limited to, an electronic, magnetic, optical, electromagnetic, infrared, or semiconductor system, apparatus, or device, or any suitable combination of the foregoing.

In accordance with one embodiment of the present invention, the system 10 and a related method of operation may restore the contents of one file server, physical volume, or file share, hereafter called the recovery storage system, or source, to another file server, physical volume, or file share, hereafter called the restore storage system, or destination, by copying one set of recovery files as the files themselves and copying the complementary set of files only as symbolic links to the source files.

Without loss of generality, and as an exemplary embodiment, the set of source files that are copied as files may be those files that are more commonly or recently accessed and the complementary set of source files that are copied as links may be those files that are less commonly or recently accessed. The choice of files that are copied as files and files that are copied as links elsewhere in this description may refer to files more commonly accessed and less commonly accessed or may refer to files that are partitioned by any other metric.

The benefits of this embodiment of the present invention are significant. Because the copy of the recovery storage system to the restore storage system does not need to copy the contents of all the files, it should be completed more quickly. Also, because the restore storage system is likely to be more performant and probably more expensive, the reduced size taken by the copy of the recovery files is less expensive while still giving virtually all the performance improvements.

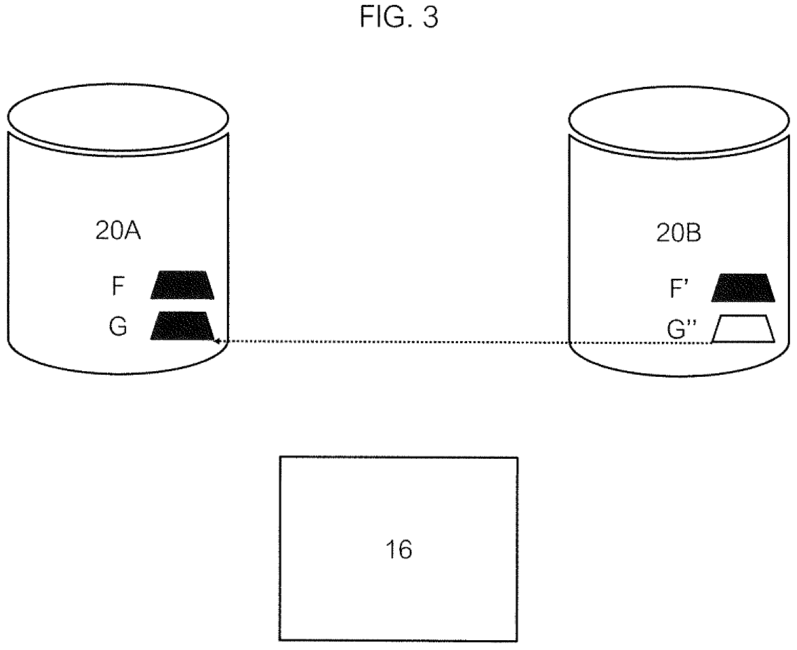

The system 10 of FIG.1 may have multiple servers 20. Referring to FIG. 3, two file servers 20, volumes, or shares may be seen. In this embodiment, the server 16 may operate as the electronic file handling system representing this embodiment of the invention. The server 16 may copy an example file labeled F from the source server 20A to a destination server 20B as a complete file labeled F. The server 20K copies an example file labeled G from the source server 20A to the destination server 20B as a symbolic link labeled G″ referring back to source file G.

In accordance with one embodiment, the server 20A may be labeled as the recovery storage server 20A and the server 20B may be labeled as the restore storage server 20B. Following the above pattern data migration, the server 16 may copy every file on the recovery storage server 20A to restore storage server 2013 either as a complete file or as a symbolic link to the recovery storage server 20B, depending on whether the access to the file should be immediate or if the tradeoff of access redirected by a symbolic link is acceptable based on the lower probability of access and the lower space occupied by the symbolic link. For example, the set of source files that are copied as files may be those files that are more commonly or recently accessed (i.e., accessed after a predetermined date/timeframe) and the complementary set of source files that are copied as links may be those files that are less commonly or recently accessed.

Files that are the same size or smaller than the size of the symbolic link that would refer to them, or files that are larger than the size of the symbolic link but below another threshold size, may be copied as a whole file in lieu of being linked.

Another aspect of an embodiment of the present invention continues to migrate files from the recovery storage server 20A to the restore storage server 2013 even after the restore storage server 20B becomes the primary storage server, but this time overwriting links that were previously copied as links with copies that are complete files. The files that were previously copied as links are again divided into two sets, one set of files that should be copied to the restore storage server 20B as files and the complementary set that should remain copied to the restore storage server 20B as links. This can be repeated until all desired files, or all files, from the recovery storage server 20A are copied to the restore storage server 20B.

Another aspect of an embodiment of the present invention copies files to the destination not by using a symbolic link to the original source file but rather by a dynamic symbolic link in the style of Patent Number 10,198,447.

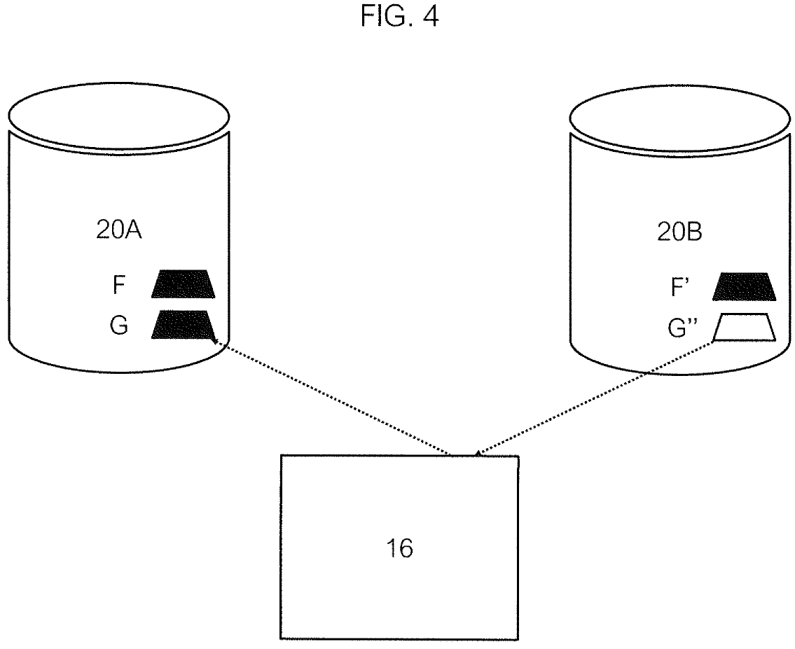

FIG. 4 shows the same two file servers of FIG. 3 and the electronic file server 16. In this embodiment, the symbolic links written on restore storage server 20B refer not to the original source files on recovery storage sever 20A, but rather to the server 16, which dynamically determines what file on the recovery storage server 20A is referred to by the redirected path in the symbolic link. The redirected path in the symbolic link may be isomorphic to the original path on the recovery storage server 20A, or it could be a reference to the file in some other form that the server 16 dereferences in order to determine the original path on the recovery storage server 20A. The sever 16 may host a file system that services the file system requests for metadata and data by reading the file metadata and data from the recovery storage server 20A and delivering it in response to the file system requests.

Another aspect of an embodiment of the present invention recognizes the access of files on the server 16 handling the dynamic links and more rapidly replaces the dynamic link on the restore storage server 20B with the newly accessed file on the recovery storage server 20A. This copying of accessed files could be immediate or scheduled and happen before, during, or after any other copying based on any other policy.

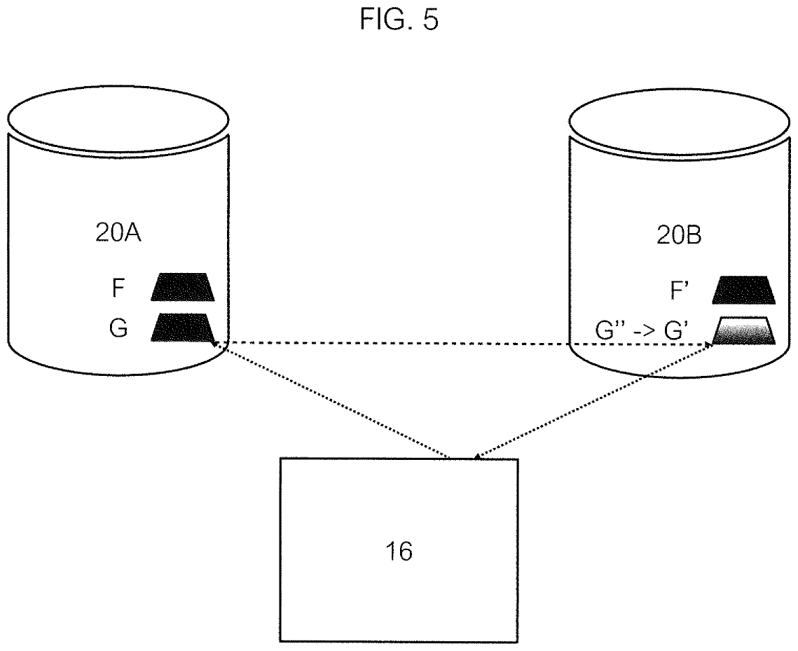

FIG. 5 shows the shows the same two file servers of FIGS. 3 and 4 and the electronic file server 16. In FIG. 5 the dynamic symbolic link G″ is accessed by a user accessing the restore storage server 20B, the user's file system client follows the symbolic link to the electronic file server 16, which serves the file to the end user and fronts the access to the recovery storage server 20A in the style of U.S. Pat. No. 10,198,447. After the access is complete, the electronic file server 16 includes file G in its next round of files restored as files from the recovery storage server 20A to the restore storage server 20B, and G is copied over G″ to make actual file G′.

Another aspect of an embodiment of the present invention recognizes the writing of files on the intelligent migration platform handling the dynamic links and more rapidly replaces the dynamic link on the restore storage server 20B with the newly written file on the recovery storage server 20A. This copying of accessed files could be immediate or scheduled and happen before, during, or after any other copying based on any other policy.

Referring to FIG. 5, in this embodiment, after the file is written through the electronic file server 16 and all writes are complete, the file is restored as a file from the recovery storage server 20A to the restore storage server 20B, and G is copied over G″ to make actual file W.

The foregoing description is illustrative of particular embodiments of the application but is not meant to be a limitation upon the practice thereof. The following claims, including all equivalents thereof, are intended to define the scope of the application.

What is claimed is:

1. An electronic file migration system comprising:
a processor;
a memory coupled to the processor, the memory storing program instructions that when executed by the processor, causes the processor to:
copy a plurality of files from a source storage device to a destination storage device, wherein a first set of files are copies of the first set of files and a second set of files are copied as symbolic links to the second set of files.

2. The electronic file migration system of claim 1, wherein the first set of files are files that have been accessed after a predetermined date.

3. The electronic file migration system of claim 1, wherein the symbolic links are links to the second set of files stored on the source storage device.

4. The electronic file migration system of claim 1, wherein individual files of the second set of files are copied as individual files themselves when a size of the individual file of the second set of files is smaller than a size of a corresponding symbolic link,

5. The electronic file migration system of claim 1, wherein individual files of the second set of files are copied as individual files themselves when one of: a size of the individual file of the second set of files is equal to or smaller than a size of a corresponding symbolic link, or the size of the individual file of the second set of files is larger than the size of the corresponding symbolic link but below a threshold size.

6. The electronic file migration system of claim 1, wherein the memory storing program instructions that when executed by the processor, causes the processor to: run multiple save iterations, with each save iteration increasing a number of the first set of files by replacing previously created symbolic links on the destination storage device with copies of corresponding files stored on the source storage device.

7. The electronic file migration system of claim 1, wherein the memory storing program instructions that when executed by the processor, causes the processor to: refer to the electronic file migration system to dynamically determine what file on the source storage device is referred to by a redirected path in the symbolic link as the symbolic link stored on the destination storage device refers to the electronic file migration system and not to an original source file.

8. The electronic file migration system of claim 7, wherein the redirected path in the symbolic link is isomorphic to an original path on the source storage device.

9. The electronic file migration system of claim 7, wherein the redirected path in the symbolic link is reference to the file that the electronic file migration system dereferences to determine the original path on the source storage device.

10. The electronic file migration system of claim 1, wherein the memory storing program instructions that when executed by the processor, causes the processor to: copy any of the plurality of files that are accessed, modified, created, or deleted on the source storage device to the destination storage device.

11. An electronic file migration system comprising:
a processor;
a memory coupled to the processor, the memory storing program instructions that when executed by the processor, causes the processor to:
copy a plurality of files from a source storage device to a destination storage device, wherein a first set of files are copies of the first set of files and a second set of files are copied as symbolic links to the second set of files, wherein the first set of files are files that have been accessed after a predetermined date and the symbolic links are links to the second set of files stored on the source storage device.

12. The electronic file migration system of claim 11, wherein individual files of the second set of files are copied as individual files themselves when a size of the individual file of the second set of files is smaller than a size of a corresponding symbolic link.

13. The electronic file migration system of claim 11, wherein individual files of the second set of files are copied as individual files themselves when one of: a size of the individual file of the second set of files is equal to or smaller than a size of a corresponding symbolic link, or the size of the individual file of the second set of files is larger than the size of the corresponding symbolic link but below a threshold size.

14. The electronic file migration system of claim 11, wherein the memory storing program instructions that when executed by the processor, causes the processor to: run multiple save iterations, with each save iteration increasing a number of the first set of files by replacing previously created symbolic links on the destination storage device with copies of corresponding files stored on the source storage device.

15. The electronic file migration system of claim 11, wherein the memory storing program instructions that when executed by the processor, causes the processor to: refer to the electronic file migration system to dynamically determine what file on the source storage device is referred to by a redirected path in the symbolic link as the symbolic link stored on the destination storage device refers to the electronic file migration system and not to an original source file.

16. The electronic file migration system of claim 15, wherein the redirected path in the symbolic link is isomorphic to an original path on the source storage device.

17. The electronic file migration system of claim 15, wherein the redirected path in the symbolic link is reference to the file that the electronic file migration system dereferences to determine the original path on the source storage device.

11. electronic file migration system of claim 11, wherein the memory storing program instructions that when executed by the processor, causes the processor to: copy any of the plurality of files that are accessed, modified, created, or deleted on the source storage device to the destination storage device.
